(19) United States
(12) Patent Application Publication
(10) Pub. No.: US 2014/0111700 A1
(43) Pub. Date: Apr. 24, 2014

(54) METHOD AND APPARATUS FOR SECOND SCREEN CONTROL

(71) Applicants: Garry M. Paxinos, Pompano Beach, FL (US); Anastasios Kyriakides, Hollywood, FL (US); Kenneth Alvin Hosfeld, Coral Spring, FL (US); Anastasios Nicholas Kyriakides, II, Plantation, FL (US)

(72) Inventors: Garry M. Paxinos, Pompano Beach, FL (US); Anastasios Kyriakides, Hollywood, FL (US); Kenneth Alvin Hosfeld, Coral Spring, FL (US); Anastasios Nicholas Kyriakides, II, Plantation, FL (US)

(21) Appl. No.: 14/057,402

(22) Filed: Oct. 18, 2013

Related U.S. Application Data
(60) Provisional application No. 61/715,527, filed on Oct. 18, 2012.

(51) Int. Cl. H04N 5/44

(52) U.S. Cl. CPC H04N 5/4403
USPC 348/734

(57) ABSTRACT

A method, apparatus and system to provide the ability for the user interfaces (i.e. viewing, navigating, searching, finding) of modern entertainment system devices to be operated on and controlled by commercially available handheld electronic devices. Applicants' second screen control method and apparatus comprises a Primary Screen and a Secondary screen. The Secondary Screen, embodied on a handheld electronic device, displays the typical on-screen information and may also display Internet content and allow one to simultaneously interact with the social media systems. The Primary Screen, typically embodied as TV set, displays the selected program. Social media information relating may also be displayed on the Primary Screen simultaneously with the selected video content, as directed by the Secondary Screen, in a variety of modalities including overlay and squeeze back.

### CROSS REFERENCE TO RELATED APPLICATIONS

This application claims the benefit of and incorporates by reference co-pending U.S. provisional patent application Ser. No. 61/715,527 filed Oct. 18, 2012.

### BACKGROUND OF THE INVENTION

1. Field of the Invention

This invention relates generally to electronic device controls and, more particularly, to a method and apparatus for interacting with a display device with a discrete handheld device.

2. Description of the Prior Art

Television (or “TV”) services which provide video live or recorded video content through channels such as over air broadcasts, cable TV systems, and satellite TV systems (“provider video content” or “TV style video content”) are well known. Over air broadcasts have been offered for decades, but typically only permit access to a few channels (five to ten). Cable TV and satellite systems have grown in popularity over the past few decades and typically offer a greater number of channels and interactive services such as recording and playback and premium content for purchase aimed at improving aspects of the user's viewing experience. Cable TV and satellite systems also typically provide access to these channels and services through on screen menus which are very simple to navigate and eliminate need of complex search processes. Recently, access to TV style video content has additionally been availed through the Internet, where such video can often be streamed for real time viewing and/or downloaded for subsequent viewing. On the Internet, many of the service enhancements which have been introduced by Cable TV and satellite systems are present in some form. In many cases, however, TV style video content delivered over the Internet is still offered by a large number of discrete content providers, and these services often can only be accessed by an Internet browser and require a computer and a powerful searching engine. Nonetheless, as long as the need to navigate through available content and locate desired material exists, there remain opportunities to further enhance the capability and ease in which a user accomplishes the same.

As access to content as grown, so have the capabilities of the TV sets on which the content is viewed. For example, many contemporary TV sets include networking components which allow them to access the Internet or other data networks. Similarly, in recent times, there been an exponential increase in the sophistication of handheld electronic devices, such as mobile phones (including “smart” phones) and tablets. As such, the use of such devices is no longer limited to making phone calls or saving calendar entries. A problem which still exists, however, is that despite such improvements in technology, most TV set users still operate the TV set by way of a proprietary/preconfigured or universal/configurable remote control. Such remote controls typically have no other use than to operate the associated TV set or media receiver/player (i.e. DVD player, cable box, digital media receivers)(collectively, “entertainment system devices”). Thus, there remains a need for a method and apparatus which could provide the ability for entertainment system devices to be operated by a handheld electronic device, or “secondary screen.” It would be helpful if such a second screen control method and apparatus was structured to allow typical on screen menus for entertainment system devices to be displayed and interacted with on the second screen. It would be additionally desirable for such a second screen control method and apparatus to be structured allow a user to interact on various social media outlets in association with such second screen control.

The Applicant's invention described herein provides for a method and apparatus adapted to facilitate secondary screen control for entertainment system devices. The primary components of Applicants' second screen control method and apparatus include at least one entertainment system device and a handheld electronic device configured to connect to said entertainment system device by way of a data network. When in operation, the second screen control method and apparatus allows a user control an entertainment system devices and perform functions such as selecting programming or display social media content from a commercially available handheld electronic device. As a result, many of the limitations imposed by the prior art are removed.

### SUMMARY OF THE INVENTION

A method, apparatus and system to provide the ability for the user interfaces (i.e. viewing, navigating, searching, finding) of modern entertainment system devices to be operated on and controlled by commercially available handheld electronic devices. Improvements in the underlying technologies in both entertainment system devices and handheld electronic devices, particularly in electronic data network connectivity, are leveraged in configuring such entertainment system devices and handheld electronic devices so that the handheld electronic device can perform tasks such as selecting the program or programs to be viewed on the target entertainment system device.

Applicants' second screen control method and apparatus comprises a Primary Screen and a Secondary screen. The Secondary Screen, embodied on a handheld electronic device with a touch screen, displays and allows a user to navigate through various screens showing the typical on-screen information, including but not limited to Electronic Program Guides, listing of Video On Demand, and listings of Recorded Video Content, and allow the same to be selected or actuated by the user by engaging the touch screen. The Secondary Screen may also display and allow one to simultaneously interact with the social media systems relating to the currently watched video content such as a TV program (or show) or web-based video content or similar content. The Primary Screen, which in one embodiment may be an LCD, plasma, projector, LED or similar technology TV or other video display screen, may show auxiliary information while also playing selected video content such as a selected TV program. Social media information or Internet content relating may also be displayed on the Primary Screen simultaneously with the selected video content, as directed by the Secondary Screen, in a variety of modalities including overlay and squeeze back. Telephony information may also be displayed on the Primary and Secondary Screens. Calls may, in fact, be positioned on the Primary Screen.

Communication between the Secondary Screen (configured as the controller) and the Primary Screen may be accomplished using a multitude of protocols, including: Representational State Transfer (“REST”), Webservices, SMS or other messaging protocols (including MMS). Communication may be configured as one way commands from the Secondary Screen to the Primary Screen only, or two way communication so as to indicate success/failure of operations or other feedback to the Secondary Screen. There may also be a plurality of controllers which are configured to enable a selection battle. With user permission, the system may also allow a customer service agent to remotely access a customer's Internet router through an analog telephone adapter or other network connected consumer device.

It is an object of this invention to provide a method and apparatus which could provide the ability for entertainment system devices to be operated by a handheld electronic device.

It is another object of this invention to provide a second screen control method and apparatus structured to allow typical on screen menus for entertainment system devices to be displayed and interacted with on the second screen.

It is yet another object of this invention to provide a second screen control method and apparatus structured allow a user to interact on various social media outlets in association with such second screen control.

These and other objects will be apparent to one of skill in the art.

### BRIEF DESCRIPTION OF THE DRAWINGS

FIG. 1 shows the main components of a second screen control method and apparatus according to one embodiment of the present invention.

FIG. 2 shows the main components of a second screen control method and apparatus according to one embodiment of the present invention.

FIG. 3 depicts an exemplary user interface of a second screen control method and apparatus according to the present invention.

FIG. 4 depicts an alternate exemplary user interface of a second screen control method and apparatus according to the present invention.

FIG. 5 shows an initialization process pairing a handheld electrical device with a entertainment system device to enable second screen control.

### DETAILED DESCRIPTION OF THE INVENTION

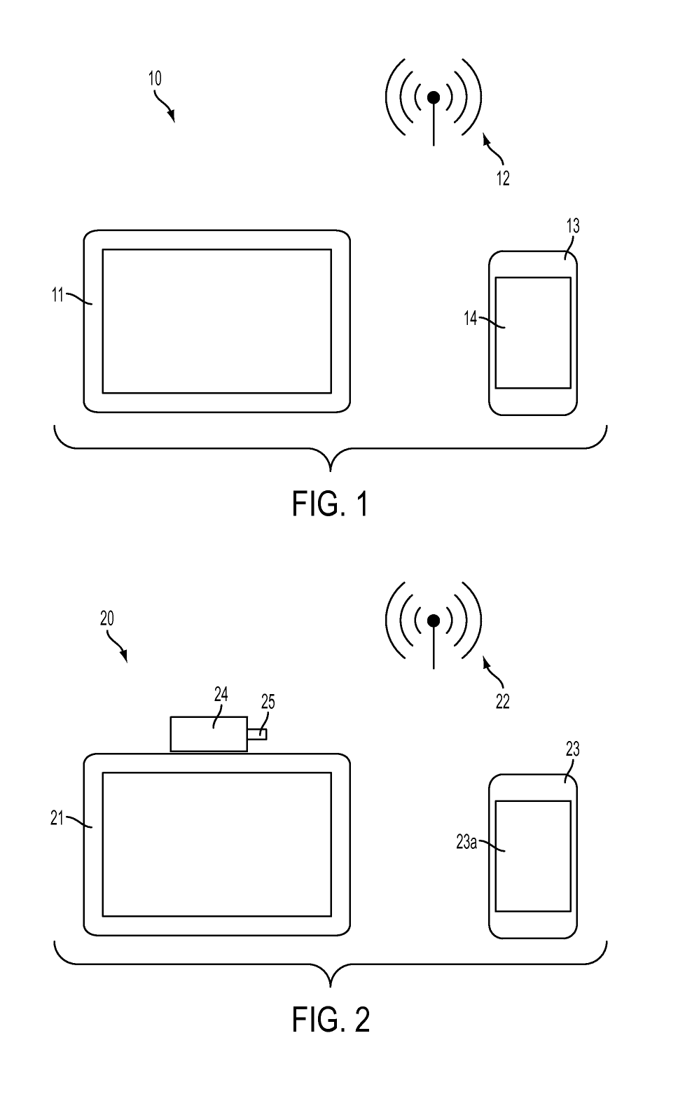

Referring now to the drawings and in particular FIG. 1, the primary components of a second screen control system 10 include an entertainment system device, defined as a TV set 11, an electronic data network 12, and a handheld electronic device, defined as a tablet 13. In one embodiment, the electronic data network 12 is defined by a WiFi network which can be accessed by both the TV set 11 and the tablet 13. In other embodiments, other networking or electronic communication protocols may be utilized in addition or in the alternative to WiFi for the electronic data network 12, including USB (or other serial) connections, Z-wave, near field communication, radio frequency, infrared, Ethernet, LTE, WiMax, and 3G/4G/Cellular data.

The TV set 11 is embodied by a commercially available modern TV set modified with a second screen control client. It is contemplated, however, that the entertainment system device may be embodied as a media player and/or receiver, such as a set top box, an Internet streaming media player, a game console, and a disc player, modified to contain the second screen control client and connected to a TV set, thereby enabling it to operate in accordance with the present invention. In the embodiment illustrated by FIG. 1, the TV set 11 must include some form of network adaptor that enables it to access and communicate data over the electronic data network 12. The TV set 11 is modified to operate in accordance with the present invention through the addition of the second screen control client which facilitates the communication and transfer of commands and data between the TV set 11 and a tablet 13 which is modified as discuss below. In one embodiment, the second screen control client is implemented through a hardware and a software configuration. In alternate embodiments, the second screen control client is implemented through a software configuration.

In operation, the second screen control client interfaces with the operational aspects of the TV set 11, enabling such operational aspects to be controlled remotely. The operational aspects include the operative functions of the TV set 11 (turn on and off, change channel(s) displayed and/or inputs, adjust volume), the navigable menus or other user interface options, and playback functions for accessing and playing media or social media content as directed by the tablet 13 whether provided by the tablet, directly or indirectly, or not. The second screen control client operates in a similar manner with other media players and/or receivers devices, again interfacing with the operational aspects of the device, enabling it to actuate the operative functions of the device such as turn it on and off, control channel(s) or content displayed and/or inputs, search and access media content on local or networked databases, and access menu or other user interface options.

The tablet 13 is embodied as a commercially available advanced tablet device modified with a second screen control controller. As such, it is understood that the tablet 13 will include and a plurality of networking or electronic communication protocols and a user interface which is adapted to display desired information on a screen 14. The tablet 13 is modified to operate in accordance with the present invention through the addition of the second screen control controller which facilitates the communication and transfer of commands and data between the tablet 13 and the TV set 11 or other configured entertainment system device. In one embodiment, the second screen control controller is implemented through a hardware and a software configuration. In alternate embodiments, the second screen control controller is implemented through a software configuration.

In operation, the second screen control controller provides an interface on the tablet 13 on which the operational aspects of the TV set 11 can be accessed and actuated. This interface allows the available actuators, menus and related or linked content to be displayed and interacted with on the screen 14. For example, when paired with the TV set 11, the actuators would include the buttons found on a conventional remote control for that TV set 11, such as power, volume, channel, and various menu options. Along the same lines, the menus which could normally be displayed on the TV set 11 screen over whatever media content was being played or in the alternative to playing media content would instead be viewable and available to be manipulated on the screen 14. The second screen control controller additionally allows the tablet 13 to directly cause media content or social media information/content on the tablet or accessible over any available electronic data network 12 on the TV set 11. The second screen control controller operates in a similar manner with other media players and/or receivers devices, again providing the relevant actuators, menus, and the ability to control what is displayed/played.

Referring now to FIG. 2, the primary components of an alternate configuration of a second screen control system 20 include an entertainment system device, defined as a TV set 21, an electronic data network 22, a handheld electronic device, defined as a mobile phone 23, a set top box 24, and a USB interface 25. In this configuration, electronic data network 22 and the mobile phone 23 are configured as the electronic data network 12 and tablet 13 were, respectively, in FIG. 1. The TV set 21 is adapted to play media content as provided by the set top box 24 as opposed to provided directly through a cable, satellite or Internet connection. In this configuration, it is contemplated that the set top box 24 maintains the connection to a source of media content, such as cable, satellite or one or more Internet providers and simply controls the content displayed on the TV set 21 by way of a connection protocol such as coaxial, USB, Ethernet, WiFi, WiMax, TOSLINK, SP/DIF, HDMI, component, and composite. Consequently, in this configuration, it is the set top box 24 which is configured to connect to the electronic data network 22 and is modified to operate in accordance with the present invention through the addition of a second screen control client which facilitates the communication and transfer of commands and data between the set top box 24 and a phone 23. In one embodiment, the set top box 24 is modified as such through the use of a USB interface 25 which is removably connected to the set top box 24. The USB interface 25 includes the software which modifies the set top box 24 and enables the second screen control client to interface with and operate the set top box 24. In other embodiments, the set top box 24 can be modified with the second screen control client through the use of infrared or network signals, internal hardware and software or just software. Due the configuration, particularly the inclusion of the second screen control client, the phone 23 is able to interface and operate the set top box 24 in the substantially the same manner as the tablet 13 operated the TV set 11.

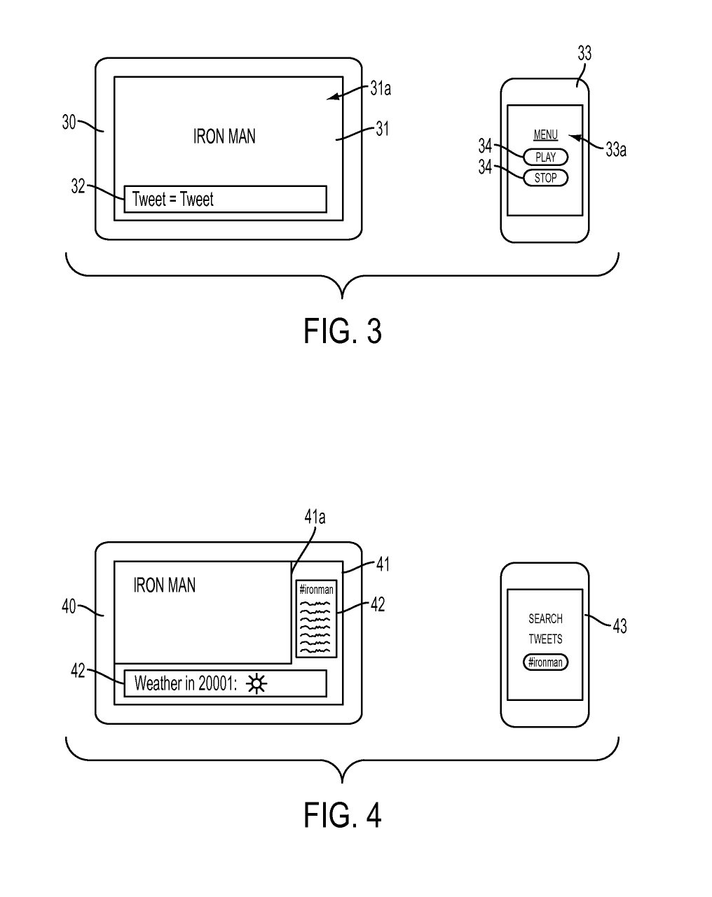

Referring now to FIG. 3, when social media content or other information from the Internet (such as news scrolls) is desired to be added to a TV set 30 at the same time that provider media content (defined as live or recorded video content through channels such as over air broadcasts, cable TV systems, and satellite TV systems) is being viewed, the second screen control client, at the direction of the second screen control controller, allows the content to be placed as an overlay on top of the traditional media content 31a being displayed on the viewable screen 31 of the TV set 30. In accordance with the same, the traditional media content 31a remains in its full size across the screen 31 and an overlay section 32 containing the content or information selected by the mobile device 33 containing the social media control controller is placed over top of it in a desired location on the screen 31. As previously detailed, a tablet 33 is employed to view, navigate through, and actuate various screens 33a, including a screen 33a having relevant actuator buttons 34 for the current operation of the TV set 30.

Referring now to FIG. 4, another manner in which a user can add social media content or other information from the Internet when desired to a TV set 40 is by the squeeze back function enabled by the second screen control client at the direction of the second screen control controller. The squeeze back function causes the size of the traditional media content 41abeing displayed on the viewable screen 41 to be reduced and located in a manner which creates empty space on the screen 41. In this empty space, one or more content windows 42 can be added to display the desired social media content or other information from the Internet as selected by the mobile device 43 containing the social media control controller. While it is detailed above that the social media control controller on the mobile device 43 allows for substantially full control of the TV set 40, it is understood that while that occurs, the mobile device continues to maintain the ability to perform its customary functions. As exemplified in FIG. 4, when configured with the social media control controller, the mobile device 43 has the added ability to cause to be displayed various screens or windows relating to its general operations. It is contemplated that this added ability includes Internet searching, playing locally stored or network accessible media directly, and performing voice or voice and video calls.

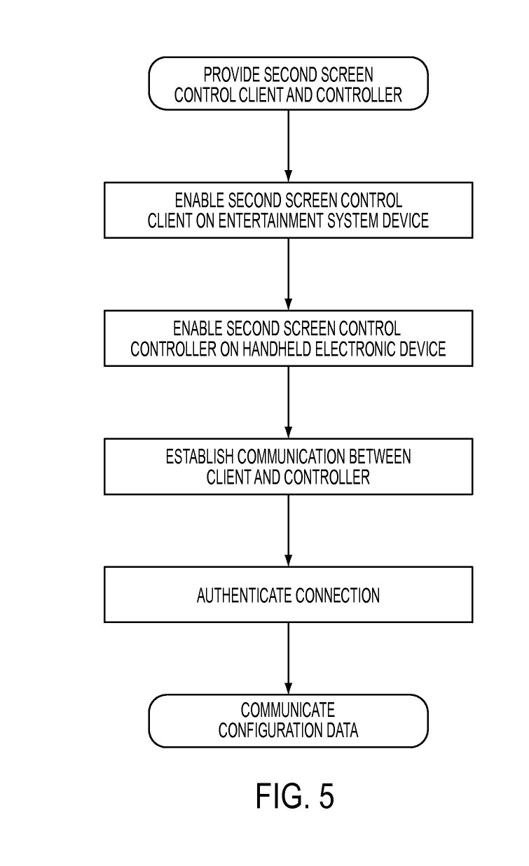

Referring now to FIG. 5, when a second screen control system is desired to be implemented, the process for doing so begins with the provision of a mobile device and an entertainment system device with the second screen control controller and second screen control client, respectively. Once each device is provided in accordance with the same, the second screen control client and the second screen control controller must be enabled on the respective devices. When the second screen control client is enabled, it identifies the nature of the device, identifies the content and extent of the available user interfaces and communication protocols available and present, accesses the main controller or controllers in the device to enable it to interface with, replicate, and control the identified user interfaces, and begins transmitting an enable signal which allows it to be located and identified by a second screen control controller on the identified communication protocols. Once a connection with a desired device containing a second screen control controller is established, the second screen control client ceases to transmit this enable signal. It is contemplated that when a messaging service protocol is desired to be utilized for second screen control, such as SMS or MMS, the second screen control client must be additionally configured to periodically send an enabled message to the telephone number or short code for the mobile device.

When the second screen control controller is enabled, it searches for a second screen control client and provides an on screen menu to allow a user to view and identify the devices found to having an enable signal transmitting and the available data networks through which the signal has been received. In one embodiment, the search is performed using commercially available search technology such as Bonjour (software), UPnP. Once the user selects a entertainment system device she desires to link with the mobile device for secondary screen control and the data network desired to be used, the second screen control controller establishes a communication link and the second screen control client. Once connected, the second screen control client and second screen control controller on the respective devices authenticate their connection, which includes checking for errors and allowing the user to confirm on the device containing the second screen control controller the desired data network to use for the network connection. In some embodiments, the user will additionally have to enter a code or password which unlocks access to the second screen control client. Once authenticated, the second screen control client and second screen control controller begin causing their respective devices to transmit configuration data to the other device. This step includes the transmission of data relating to actuators and menus of the entertainment system device to the mobile device. In embodiments wherein network types such as LAN, WAN, or a cellular data (3G/4G), this and subsequent data is communicated via packet format. In embodiments wherein messaging service protocols (i.e. SMS, MMS) are used for as the data network, this and subsequent data is communicated via the transmission of a plurality of messages containing bits of information.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for second screen control of an entertainment system device, comprising the steps of:
providing a handheld electronic device having a display screen and adapted to communicate electronic data over at least one electronic data network;
configuring the entertainment system device to communicate electronic data at least relating to operational aspects of the entertainment system device to be remotely controlled over the at least one electronic data network; and
configuring the handheld electronic device to communicate electronic data with said entertainment system device in real time, enabling said handheld electronic device to remotely control at least one operational aspect of the entertainment system device.

2. The method of claim 1, wherein:
said entertainment system device is configured to communicate electronic data relating to operative functions of the entertainment system device; and
said handheld electronic device is configured to remotely control at least one of the operative functions of the entertainment system device.

3. The method of claim 1, wherein:
said entertainment system device is additionally configured to communicate electronic data relating to user interfaces available on the entertainment system device; and
said handheld electronic device is configured to remotely display and control at least one of the user interfaces of the entertainment system device.

4. The method of claim 1, wherein:
said entertainment system device is configured to communicate electronic data relating to playback functions of the entertainment system device; and
said handheld electronic device is configured to remotely control at least the playback functions of the entertainment system device.

5. The method of claim 1, wherein the electronic data is communicated between the entertainment system device and the handheld electronic device in packet format over the electronic data network.

6. The method of claim 1, wherein the electronic data network include a messaging service protocol and the electronic data is communicated between the entertainment system device and the handheld electronic device over said electronic data network by way of at least one message transmitted via said messaging service protocol.

7. A method for second screen control of an entertainment system device, comprising the steps of:
providing a handheld electronic device having a display screen and adapted to communicate electronic data over at least one electronic data network;
configuring the entertainment system device to communicate electronic data relating to operative functions, user interfaces, and playback functions of the entertainment system device to be remotely controlled over the at least one electronic data network; and
configuring the handheld electronic device to communicate electronic data with said entertainment system device in real time, enabling said handheld electronic device to remotely control at least one of the operative functions, user interfaces, and playback functions of the entertainment system device.

8. The method of claim 7, wherein the configuration of said entertainment system device includes the provision of a second screen control client.

9. The method of claim 8, wherein the configuration of said handheld electronic device includes the provision of a second screen control controller.

10. The method of claim 8, wherein said second screen control client is implemented through a discrete interface device.

11. The method of claim 10, wherein the discrete interface device is defined as a USB drive.

12. The method of claim 12, wherein said entertainment system device is defined by a device which causes provider media content or other media content to be broadcast by a TV set.

13. The method of claim 12, wherein said handheld electronic device is configured to display and allow for navigating through menus generated by the entertainment system device.

14. The method of claim 12, wherein said handheld electronic device is configured to cause the entertainment system device to cause to be displayed media or social media content provided by the handheld electronic device directly or indirectly simultaneously with the display of provider media content.

15. The method of claim 14, wherein the entertainment system device is configured to cause media or social media content provided by the handheld electronic device to be displayed covering a portion of the provider media content.

16. The method of claim 14, wherein the entertainment system device is configured to cause the broadcast of the provider media content to be adjusted, enabling the media or social media content provided by the handheld electronic device to be displayed without covering the provider media content.

17. The method of claim 12, wherein said entertainment system device is defined by a media player/receiver device.

18. The method of claim 12, wherein said entertainment system device is defined by a TV set.

19. A system for second screen control of an entertainment system device, comprising
an electronic data network;
an entertainment system device defined by a device which causes provider media content or other media content to be broadcast by a TV set, wherein said entertainment system device is configured to communicate electronic data relating to operative functions, user interfaces, and playback functions of the entertainment system device to be remotely controlled over the at least one electronic data network; and
a handheld electronic device having a display screen and adapted to communicate electronic data over at least one electronic data network, wherein said handheld electronic device is configured to communicate electronic data with said entertainment system device in real time, enabling said handheld electronic device to remotely control at least one of the operative functions, user interfaces, and playback functions of the entertainment system device.

20. The system of claim 19, wherein said handheld electronic device is configured to display and allow for navigating through menus relating to provider media content available as well as cause the entertainment system device to cause to be displayed media or social media content provided by the handheld electronic device directly or indirectly simultaneously with the display of provider media content.
